(19) United States
(12) Patent Application Publication
(10) Pub. No.: US 2002/0039259 A1
(43) Pub. Date: Apr. 4, 2002

(54) Magnetic disk device

(75) Inventors: Toshisada Koyama, Kitasaku-gun (JP); Kunihiro Tsuchiya, Usui-gun (JP)

Correspondence Address: OLIFF & BERRIDGE, PLC, P.O. BOX 19928, ALEXANDRIA, VA, 22320, US

(73) Assignee: MINEBEA CO.,LTD., Kitasaku-gun (JP)

(21) Appl. No.: 09/951,441

(22) Filed: Sep. 14, 2001

(30) Foreign Application Priority Data
Sep. 26, 2000 (JP) 2000-292455

(51) Int. Cl. G11B 5/55

(52) U.S. Cl. 360/264.4

(57) ABSTRACT

A magnetic recording disk device achieving higher speed, larger capacity and higher reliability. The disk device includes two or more actuator blocks that are individually and rotatably supported, and a device driver that causes a magnetic head of each of the actuator blocks to access its associated magnetic disk to arbitrarily perform read/write operations. The device driver is provided with a logic for driving, at an arbitrary RAID level, the magnetic heads of the respective actuator blocks and the magnetic disks accessed by the magnetic heads. By handling the magnetic head of each actuator block and the magnetic disk accessed by the magnetic head as one unit to implement a necessary function, a single magnetic disk device can be used as a simplified version equivalent to a RAID system.

### BACKGROUND OF THE INVENTION

1. Field of the Invention

The present invention relates to a technology for achieving a higher speed, a larger capacity and higher reliability of a magnetic recording disk device.

2. Description of the Related Art

FIG. 4 schematically shows an internal structure of a conventional hard disk drive. A plurality of magnetic disks D are arranged on a rotating axis C₁ at equal spacing, and integrally drivingly rotated by a spindle motor (not shown). Data is read from and written to the magnetic disks D by a head stack assembly (HSA) 1. The HSA 1 is equipped with a plurality of head suspensions 2 supporting magnetic heads (not shown) at distal end portions thereof. A pivot assembly 4 pivotally supports an actuator block 3 having suspension support portions 3a in multiple rows for supporting the head suspensions 2.

The pivot assembly 4 is disposed on a rotating axis C₂ parallel to the rotating axis C₁ and has a shaft 5 penetrating its center. The pivot assembly 4 further has a sleeve 6 supported relative to the shaft 5 via a bearing. The actuator block 3 is secured to the sleeve 6, allowing the head suspensions 2 to swing integrally about the rotating axis C₂.

Furthermore, a coil not shown is provided on an end portion 3b of the actuator block 3 that opposes the head suspensions 2 with the rotating axis C₂ being located therebetween. Magnets are disposed so that they sandwich the coil thereby to make up a “voice coil motor”. Energizing the voice coil motor causes the HSA 1 to swing about the rotating axis C₂, enabling the magnetic head to move to a position designated by the magnetic disk.

In recent years, to increase the storage capacity of a hard disk drive, the number of stacked magnetic disks D is being further increased. Three to ten magnetic disks D are stacked as necessary, and the number of the suspension support portions 3a, which are stacked in a multi row configuration, of the actuator block 3 is further increased accordingly, thereby making it possible to support more head suspensions 2 and magnetic heads.

On the other hand, however, while speeding up data read/write operations is one of the important features demanded of a hard disk drive, the trend toward adding more magnetic heads D stacked in the multi row configuration has been making it difficult to achieve faster read/write operations to successfully deal with an increasing storage capacity. The difficulty is attributable to the following reason: since all the head suspensions 2 swing integrally, all magnetic heads supported by the head suspensions 2 move together on the disks D, making it impossible to write to or read from a plurality of magnetic disks simultaneously.

To satisfy all conditions for downsizing, increasing storage capacity, speed up writing/reading in a computer magnetic storage device such as a hard disk drive as a means to increase the capability of the computer magnetic storage device, the inventors developed a head stack assembly that is capable of separately operating, as necessary, a plurality of magnetic heads accessing magnetic disks stacked in a multi row configuration which is disclosed in the specification of Japanese Patent Application No. Hei 11-222566.

### SUMMARY OF THE INVENTION

Accordingly, it is an object of the present invention to provide a new, useful magnetic disk device equipped with the head stack assembly mentioned above, and to achieve still higher speed, a larger capacity, and higher reliability of a magnetic recording disk device.

To this end, according to the present invention, there is provided a magnetic disk device including magnetic disks stacked in a multi row configuration, a head stack assembly equipped with a plurality of independently rotatable actuator blocks for supporting magnetic heads accessing the magnetic disks, and a device driver that causes the magnetic head of each of the actuator blocks to access an associated one of the magnetic disks to arbitrarily perform read/write operations.

According to the present invention, the magnetic head of each actuator block accesses its associated magnetic disk thereby to simultaneously carry out read/write operations by accessing the plural magnetic disks in parallel. With this arrangement, the storage capacity can be increased, and the speed for writing and reading data can be also increased. The writing and reading speed is proportionate to the number of the actuator blocks. Writing the same data to a plurality of magnetic disks prevents the occurrence of data errors when reading the data

In a preferred embodiment of the present invention, the device driver is equipped with a logic for driving, at an arbitrary RAID (Redundant Array of Independent Disks) level, the magnetic heads of the respective actuator blocks and the magnetic disks accessed by the magnetic heads.

According to the present invention, a function for each application can be implemented by handling the magnetic head of each actuator block and the magnetic disk accessed by the magnetic head as one unit, permitting a single magnetic disk device to be used as a simplified version equivalent to “RAID.”

In another preferred embodiment of the present invention, the head stack assembly has a pivot assembly equipped with a plurality of pivots individually supporting a plurality of actuator blocks arranged such that the rotating shafts of the actuator blocks are disposed in series.

With this arrangement, the plural actuator blocks supporting a head suspension are individually rotated by the plural pivots, thereby making it possible to independently control the positions of the magnetic heads accessing different magnetic disks.

### BRIEF DESCRIPTION OF THE DRAWINGS

FIG. 1 is a perspective view showing an essential section of a head stack assembly employed in a magnetic disk device according to an embodiment of the present invention;

FIG. 2 is a sectional view showing a pivot assembly of the head stack assembly shown in FIG. 1;

FIG. 3 is a sectional view showing an application example of the pivot assembly shown in FIG. 2; and

FIG. 4 is a perspective view schematically showing a structure of the interior of a conventional hard disk drive.

### DESCRIPTION OF THE PREFERRED EMBODIMENTS

An embodiment in accordance with the present invention will now be described in conjunction with the accompanying drawings. The components that are the same with or equivalent to those of the conventional art will be denoted by the same reference numerals, and detailed explanation thereof will be omitted.

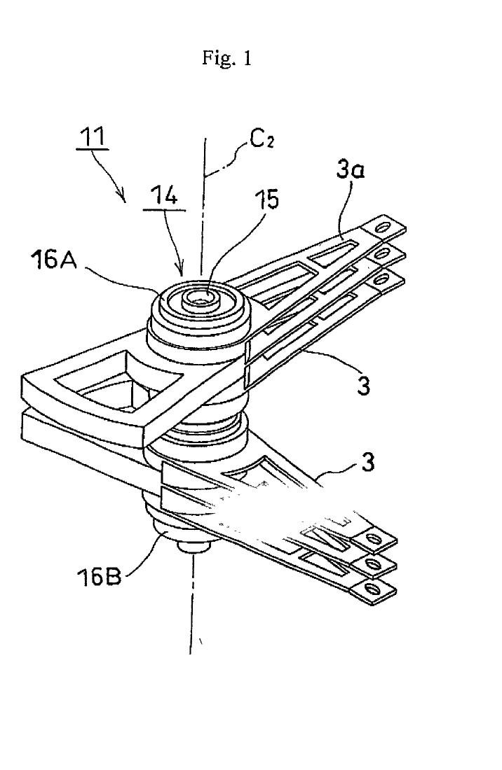

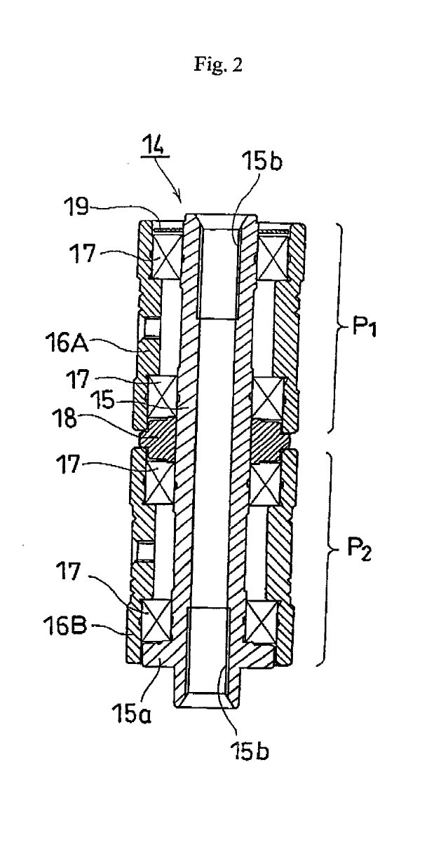

FIG. 1 shows an essential section of a head stack assembly (HSA) 11 employed in a magnetic disk device according to the embodiment of the present invention. FIG. 2 is a sectional view of a pivot assembly 14 of the HSA 11. The pivot assembly 14 has a first pivot P₁ having a sleeve 16A supported by a shaft 15 via a bearing 17, and a second pivot P₂ having a sleeve 16B supported by the shaft 15 via the bearing 17, a spacer 18 being disposed between the two sleeves 16A and 16B. A radial ball bearing is suited for the bearing 17. The spacer 18 abuts against an inner race (not shown) of the bearing 17 to retain a proper installation space between the first and second pivots P₁ and P₂.

Referring to FIG. 2, the bearing 17 located at the lower side of the second pivot P₂ abuts against a flange 15a formed on the shaft 15. With this arrangement, a desired preload can be applied to the bearings by applying an axial load to an inner race (not shown) of the bearing 17 located at the upper side of the first pivot P₁ in FIG. 2. The shaft 15 is formed as a hollow shaft, and provided with internal thread portions 15b at its both ends to allow the shaft 15 to be easily secured. A hub cap 19 prevents dust from entering into the pivot assembly 14 and also prevents dust from being discharged from the pivot assembly 14.

Referring to FIG. 1, actuator blocks 3 are secured to the sleeves 16A and 16B of the first and second pivots P₁ and P₂, respectively The actuator blocks 3 are supported in a state where the rotating shafts of the respective actuator blocks 3 are arranged in series, and supported so that they are allowed to individually rotate.

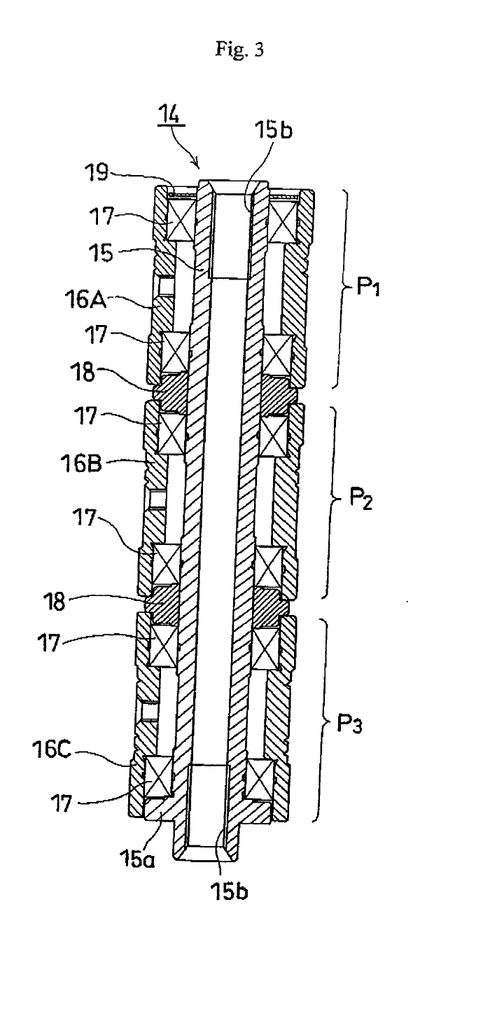

Referring to FIG. 3, a third pivot P₃ having a sleeve 16C supported by the shaft 15 via the bearing 17 can be provided, and the spacer 18 can be disposed also between the sleeve 16B and the sleeve 16C, thus providing the first, second and third pivots P₁, P₂ and P₃. This arrangement makes it possible to flexibly deal with magnetic disks D stacked in the multi row configuration. From the viewpoint of practicality, a pivot assembly 14 having five stacked pivots can be configured.

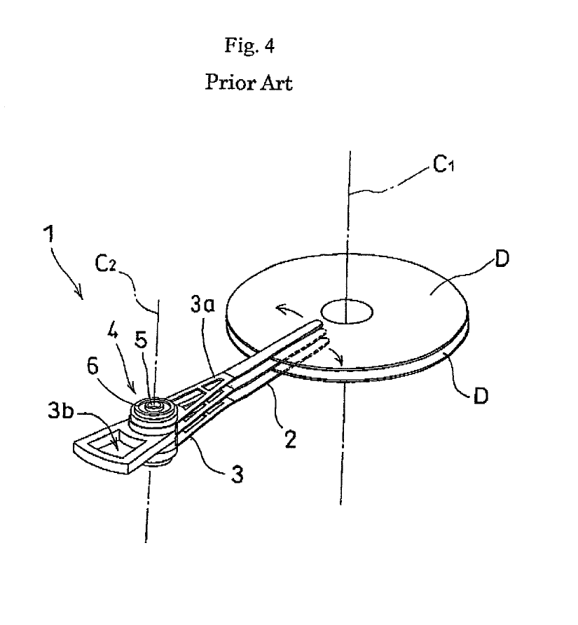

Alternatively, it is possible to provide only one suspension support portion 3a for one actuator block 3 instead of having a multi row suspension support portion 3a to support the head suspension 2 of the actuator block 3, as shown in FIG. 1. In this case, by forming each actuator block 3 so that it is thin in the axial direction, the respective head suspensions 2 can be independently swung, while keeping the total length of the pivot assembly 14 substantially the same as that of the conventional pivot assembly 4 shown in FIG. 4.

The magnetic disk device according to the embodiment of the present invention has a device driver provided for each actuator block 3. The device driver causes the magnetic head to access the magnetic disk to arbitrarily perform read/write operations. Furthermore, the device driver is equipped with a logic for driving, at an arbitrary RAID level, the magnetic head of each actuator block and the magnetic disk accessed by the magnetic head. Predetermined functions will be implemented by installing the device driver from a CD-ROM or the like into a computer that employs the magnetic disks in accordance with the present invention as recording media.

The term “RAID” refers to an external storage device that performs faster data read/write operations and exhibits higher durability against faults by using a plurality of independent hard disks in parallel as if they were a single disk device. The term “RAID level” refers to the type of RAID classified by function. Currently, there are seven available levels, from RAID 0 to RAID 6. The difference in the RAID level is irrelevant to the difference in functionality or performance.

The following will provide brief explanation on the RAID levels. RAID 0 is intended for faster read/write by dividing up data among plural hard disks. RAID 1 is intended for higher safety of data by recording the same data in two hard disks, and corresponds to the “mirroring function” or “duplexing function.” RAID 2 is used to positively carry out error check in addition to preventing faults by using a verifying hard disk in addition to a hard disk for recording data.

RAID 3 uses one hard disk for parity recording for correcting errors, and enables processing to be continued even if one hard disk encounters an error RAID 4 divides up data on a sector basis, differing from RAID 3 that divides up data on a bit or byte basis. RAID 5 assigns parity recording to individual hard disks rather than assigning to one particular hard disk.

The device driver is equipped with a logic for selecting an arbitrary RAID level from among all or several RAID levels discussed above to drive the magnetic head of each actuator block and the magnetic disk accessed by the magnetic head. If the application of the magnetic disk device according to the embodiment is determined in advance, then the device driver can be equipped with a logic only for a single RAID level.

The following operations and advantages are obtained by the embodiment of the present invention having the configuration described above.

First, the HSA 11 according to the embodiment of the present invention has two or more actuator blocks 3 that are individually and rotatably supported; hence, the positions of the magnetic heads accessing different magnetic disks can be independently controlled for each actuator block 3. This arrangement allows data to be written to or read from a plurality of magnetic disks in parallel, making it possible to speed up data read/write operations, while increasing a storage capacity at the same time. If two actuator blocks 3 are provided as in the case of the embodiment demonstrated in FIGS. 1 and 2, then the data read/write speed will be simply doubled as compared with the case where the only one actuator block supports all magnetic heads as in the prior art. In other words, the read/write speed is proportionate to the number of the actuator blocks 3.

Moreover, the magnetic disk device according to the embodiment of the present invention is provided with the device driver that causes the magnetic head of each actuator block 3 to access the associated magnetic disk to arbitrarily perform read/write operations. The device driver is provided with the logic for driving, at an arbitrary RAID level, the magnetic head of each actuator block and the magnetic disk accessed by the magnetic head.

Thus, the magnetic disk device according to the embodiment of the present invention enables a single magnetic disk device to be used as a simplified version equivalent to RAID by handling the magnetic head of each actuator block 3 and the magnetic disk accessed by the magnetic head as one unit and by imparting necessary functions thereto. The RAID employs a plurality of hard disks, and the hard disks have overlapping components, such as housings and interfaces; however, the magnetic disk device according to the embodiment of the present invention does not have such overlapping components. Moreover, the compact design of the magnetic disk device enables more flexibility in the mechanical layout in relation to other computer peripherals, as compared with RAID.

By simultaneously carrying out read/write operations by accessing a plurality of magnetic disks in parallel, the storage capacity can be increased and the data read/write speed can be increased even when only one magnetic disk device is used. Furthermore, writing the same data to plural magnetic disks makes it possible to suppress the occurrence of data errors during a read operation even when only one magnetic disk device is used. In addition, checking for errors and correction of errors can be positively performed.

In the pivot assembly 14, the first and second pivots P₁ and P₂ are pivotally supported by the same shaft 15, making it possible to modularize the shaft 15, the pivot assembly 14, the actuator blocks 3 pivotally supported by the pivot assembly 14, the head suspensions 2 supported by the actuator blocks 3, etc. Hence, there will be no difficulty in handling the magnetic heads, the head suspensions 2 and other components at the time of installation even when the number of those components is increased to accommodate more magnetic disks D stacked in the multi row configuration.

Two shafts 15 can alternatively be used, one each for the first and second pivots P₁ and P₂, and the two shafts are disposed in series to individually and rotatably support the two actuator blocks 3 having their rotating shafts arranged in series. Using the two independent shafts permits easier adjustment of the spacing between the first and second pivots P₁ and P₂. Preferably, therefore, the structure of the shaft is selected primarily according to the internal structure of a hard disk drive.

The presence of the spacer between the sleeves 16A and 16B supported by the shaft 15 via the bearings 17 makes it possible to maintain a proper spacing between the actuator blocks 3 secured to the sleeves 16A and 16B and to apply a desired preload to the bearing inside the pivot assembly 14. This arrangement enables the HSA 11 to have higher operating accuracy.

The described features of the present invention provide the following advantages. First, the magnetic disk device according to one aspect of the present invention permits still higher speed, a larger capacity and higher reliability.

According to another aspect of the present invention, a single magnetic disk device can be used as a simplified version equivalent to RAID, making it possible to prevent overlapping components that inevitably exist in a RAID system involving a plurality of hard disks. In addition, the compactly designed magnetic disk device enables more flexibility in the mechanical layout in relation to other computer peripherals, as compared with RAID.

According to another aspect of the present invention, a simplified form of RAID can be embodied using a single magnetic disk device.

What is claimed is:

1. A magnetic disk device comprising:
magnetic disks stacked in a multi row configuration;
a head stack assembly equipped with a plurality of independently rotatable actuator blocks for supporting magnetic heads accessing the magnetic disks; and
a device driver that causes the magnetic head of each of the actuator blocks to access associated magnetic disks to arbitrarily perform read/write operations.

2. A magnetic disk device according to claim 1, wherein the device driver is equipped with a logic for driving, at an arbitrary RAID level, the magnetic heads of the respective actuator blocks and the magnetic disks accessed by said magnetic heads.

3. A magnetic disk device according to claim 1 or 2, wherein the head stack assembly comprises a pivot assembly equipped with a plurality of pivots, the pivots supporting a plurality of actuator blocks being arranged so that they stand in line with the rotating shaft.
